(19) United States
(12) Patent Application Publication
(10) Pub. No.: US 2007/0294742 A1
(43) Pub. Date: Dec. 20, 2007

(54) Video Scrambling

(75) Inventor: Jeffrey R. Sprague, San Jose, CA (US)

Correspondence Address: SCIENTIFIC-ATLANTA, INC.;THOMAS, KAYDEN, HORSTEMEYER & RISLEY, 5030 SUGARLOAF PARKWAY, LAWRENCEVILLE, GA, 30044, US

(73) Assignee: Scientific-Atlanta, Inc., Lawrenceville, GA (US)

(21) Appl. No.: 11/425,221

(22) Filed: Jun. 20, 2006

(51) Int. Cl. A63F 13/00; H04N 7/16

(52) U.S. Cl. 725/153; 463/40

(57) ABSTRACT

Included are systems and methods for providing sub-divided video. At least one embodiment of a method includes dividing a video stream into sub-regions, each of the sub-regions being configured to provide motion video for display, determining positions of the sub-regions, rearranging at least one of the sub-regions from the determined positions, and facilitating display of the rearranged sub-regions of the video stream.

### TECHNICAL FIELD

The present disclosure is related to generation of sub-divided video. More specifically, the present disclosure is related to the division and arrangement of video.

### BACKGROUND

The electronics industry has provided many different forms of entertainment and functionality including television, computers, video games, computer programs, etc. However, generally speaking, these forms of entertainment do not provide an integration of different types of media and/or media streams. Oftentimes, a user can play a video game, watch a video program, or implement a screen saver. However, two or more applications are generally not available together.

Thus, a heretofore unaddressed need exists in the industry to address the aforementioned deficiencies and inadequacies.

### BRIEF DESCRIPTION

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views. While several embodiments are described in connection with these drawings, there is no intent to limit the disclosure to the embodiment or embodiments disclosed herein. On the contrary, the intent is to cover all alternatives, modifications, and equivalents.

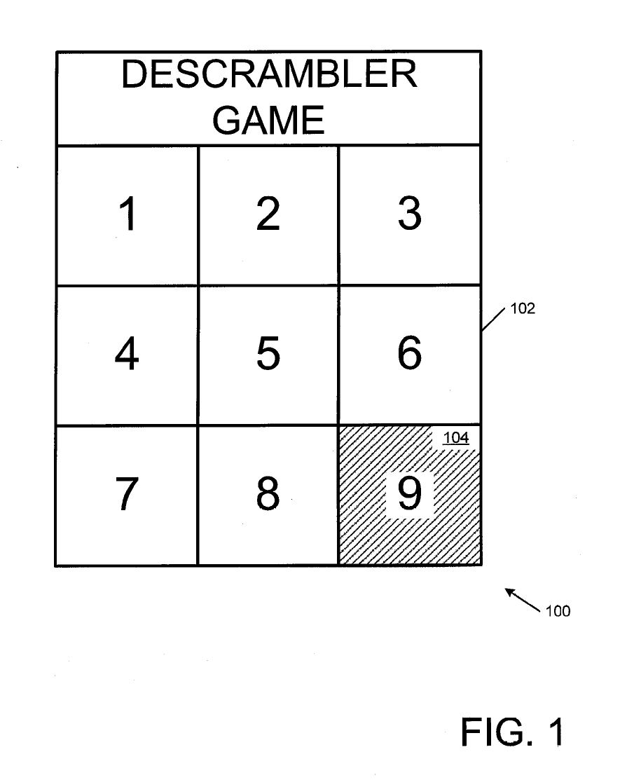

FIG. 1 is an embodiment of a descrambler game for arranging a plurality of sub-regions within an enclosed space.

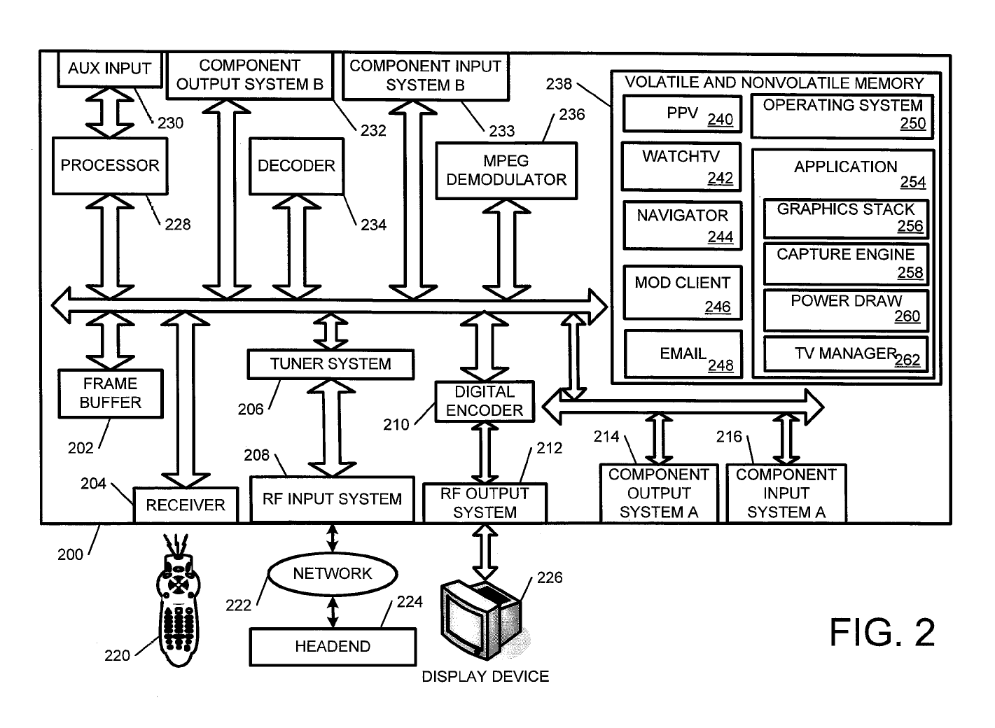

FIG. 2 is a block diagram depicting an embodiment of a computing device that may be configured to provide a video display pursuant to the present disclosure.

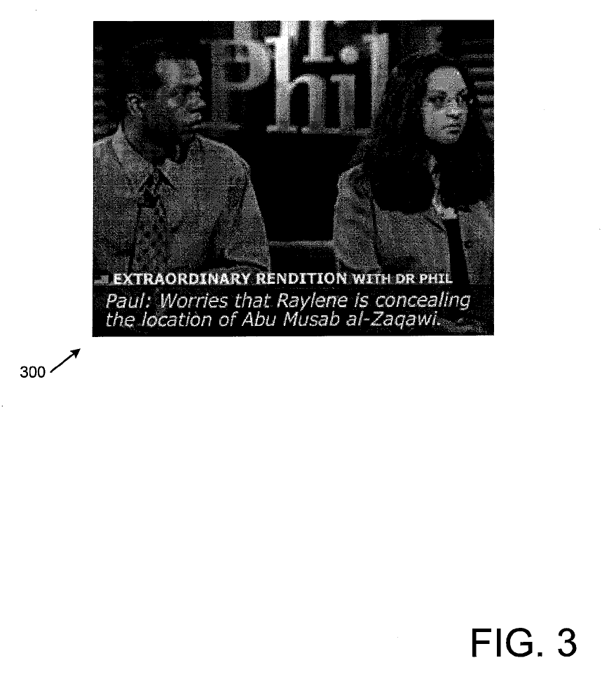

FIG. 3 is an embodiment of a video display that may be provided by the computing device from FIG. 2.

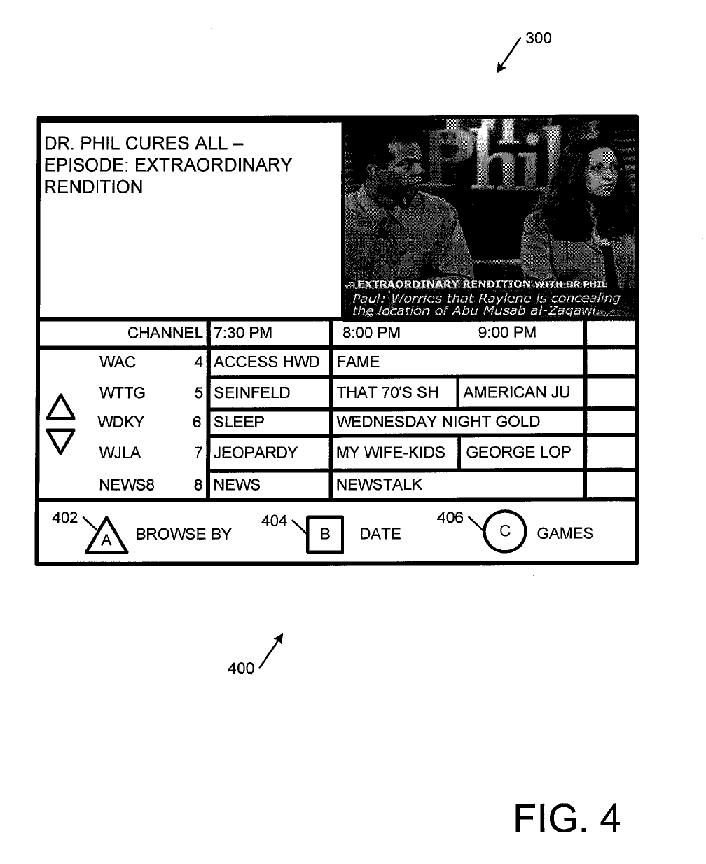

FIG. 4 is an embodiment of a video guide that may be configured to provide a games option from the video display from FIG. 3.

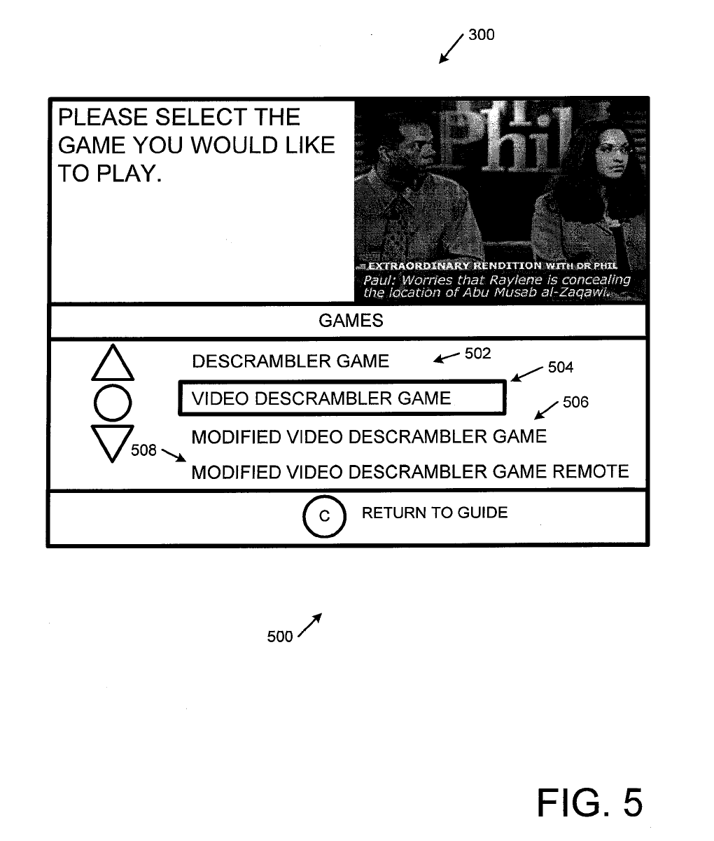

FIG. 5 is an embodiment of a games menu for selecting a version of a descrambler game, the menu being accessible via the guide from FIG. 4.

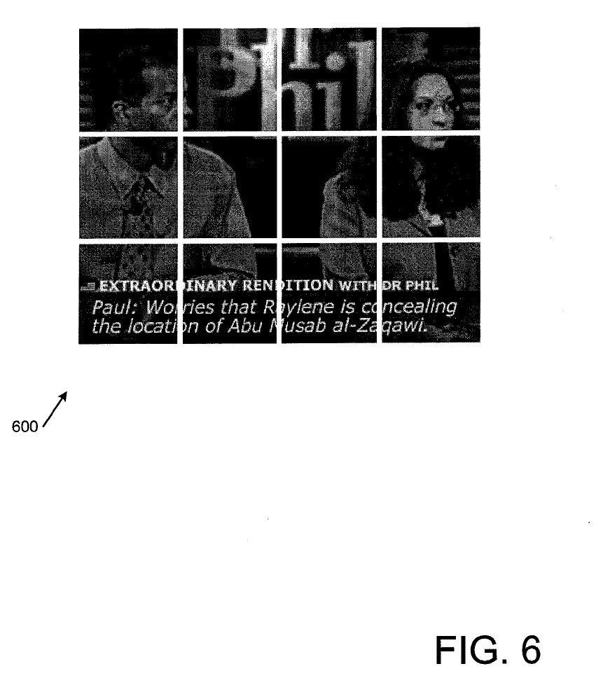

FIG. 6 is an embodiment of video divisions that may be made to provide a video scrambling functionality with the computing device from FIG. 2.

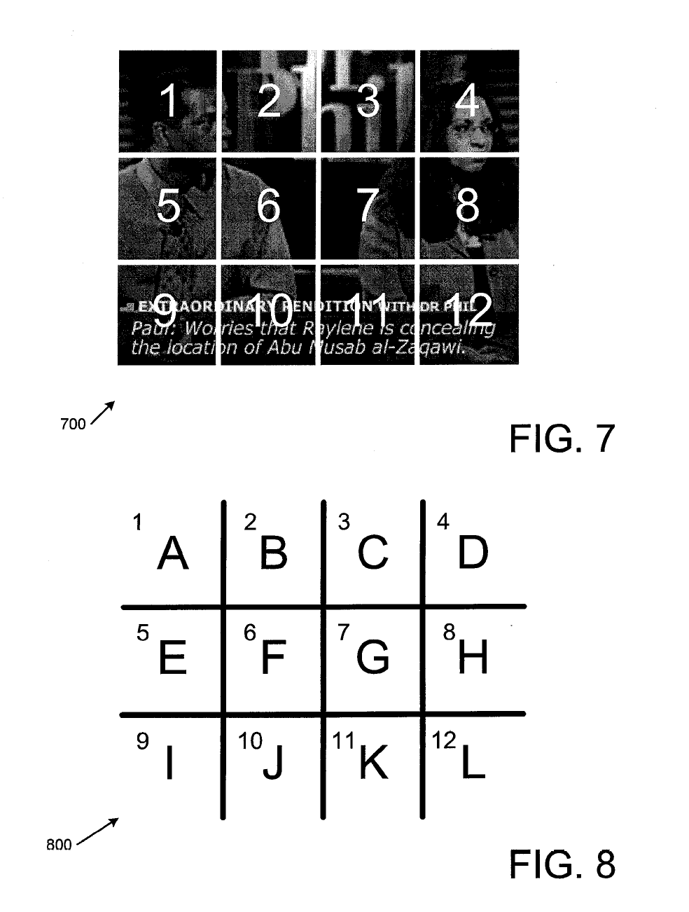

FIG. 7 is an embodiment of a destination mapping system for the video divisions from FIG. 6.

FIG. 8 is an embodiment of a source mapping system and associated destination mapping system, similar to the destination mapping system from FIG. 7.

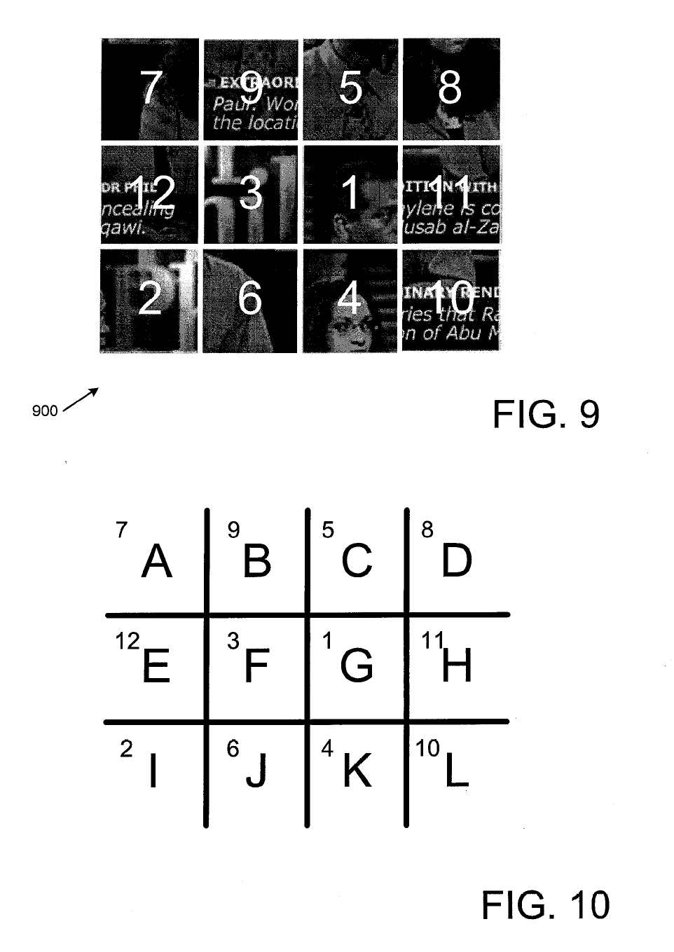

FIG. 9 is an embodiment of scrambling of a video program, according to the divisions from FIG. 6.

FIG. 10 is an embodiment of a source mapping system and associated destination mapping system pursuant to the video scrambling from FIG. 9.

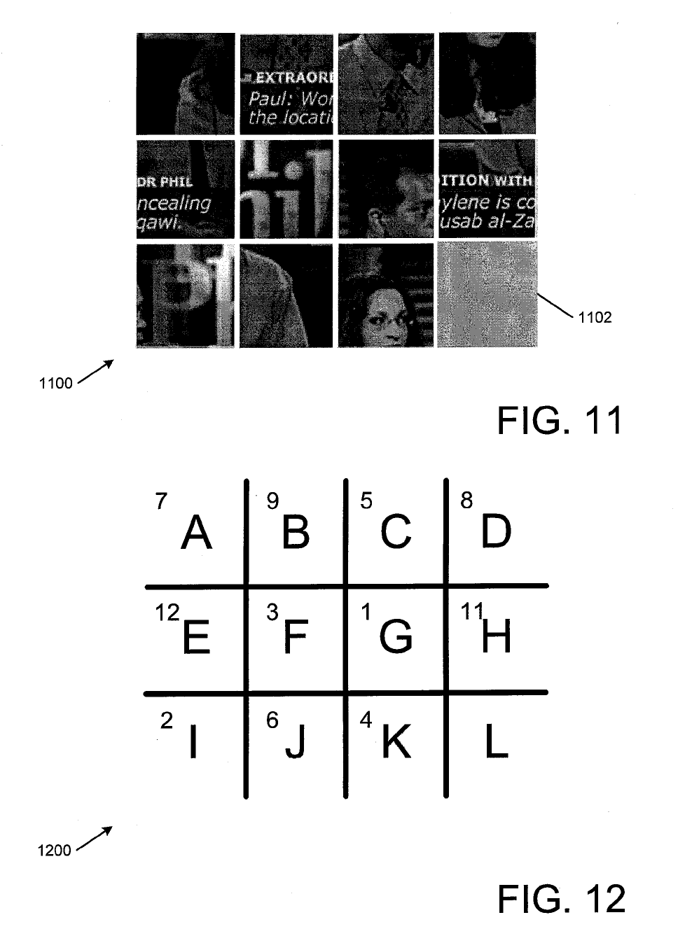

FIG. 11 is an embodiment of a video display, illustrating removal of a sub-region from the scrambled video program from FIG. 9.

FIG. 12 is an embodiment of a source mapping system and associated destination mapping system pursuant to the video display from FIG. 11.

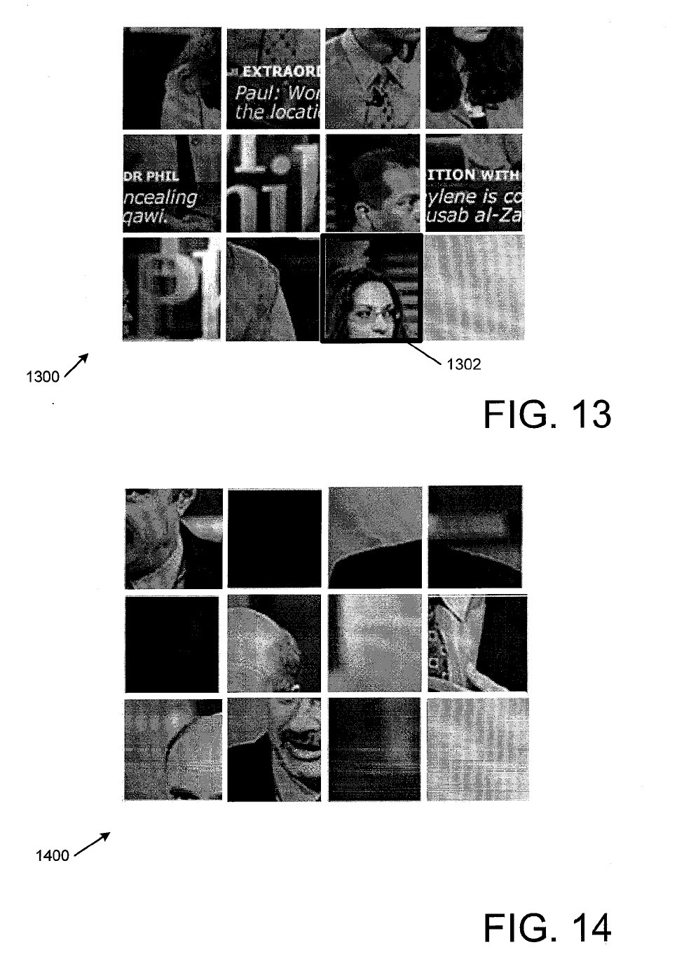

FIG. 13 is an embodiment of a video display, illustrating an on-screen user cursor for executing a descrambler game for the video display from FIG. 12.

FIG. 14 is an embodiment of a video display, illustrating the dynamic nature of video scrambling from FIG. 13.

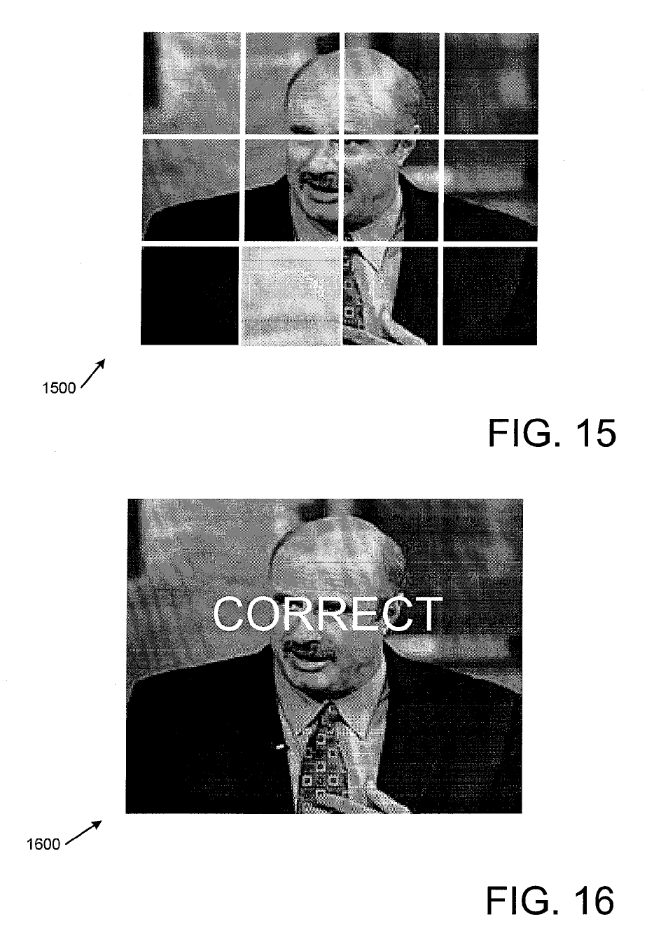

FIG. 15 is an embodiment of a video display, illustrating a desired arrangement of the sub-regions from FIG. 14.

FIG. 16 is an embodiment of a video display illustrating resuming of the video program illustrated in FIG. 15.

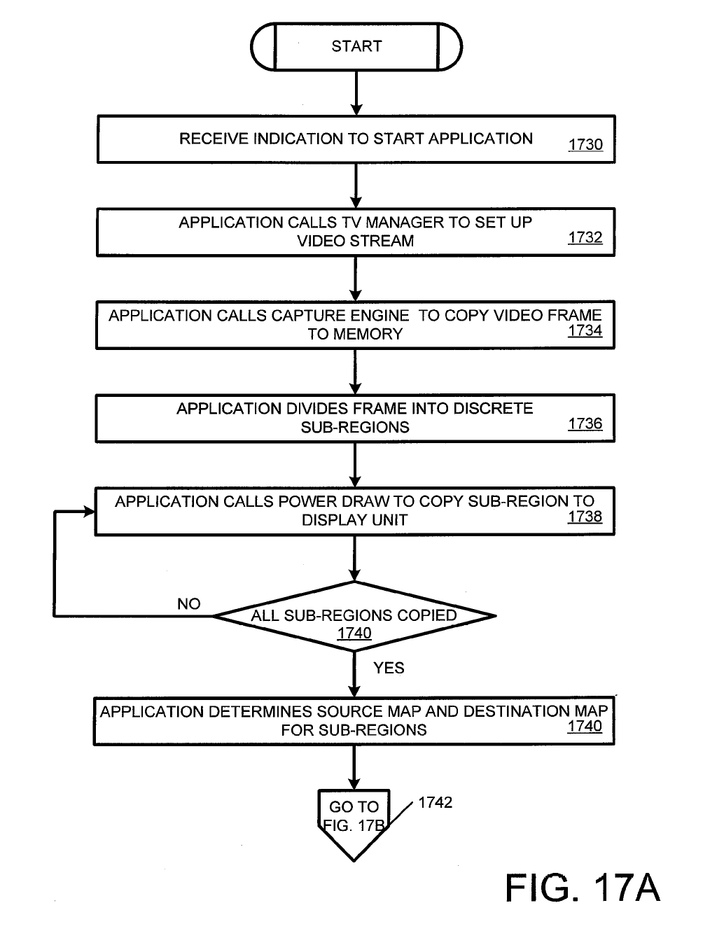

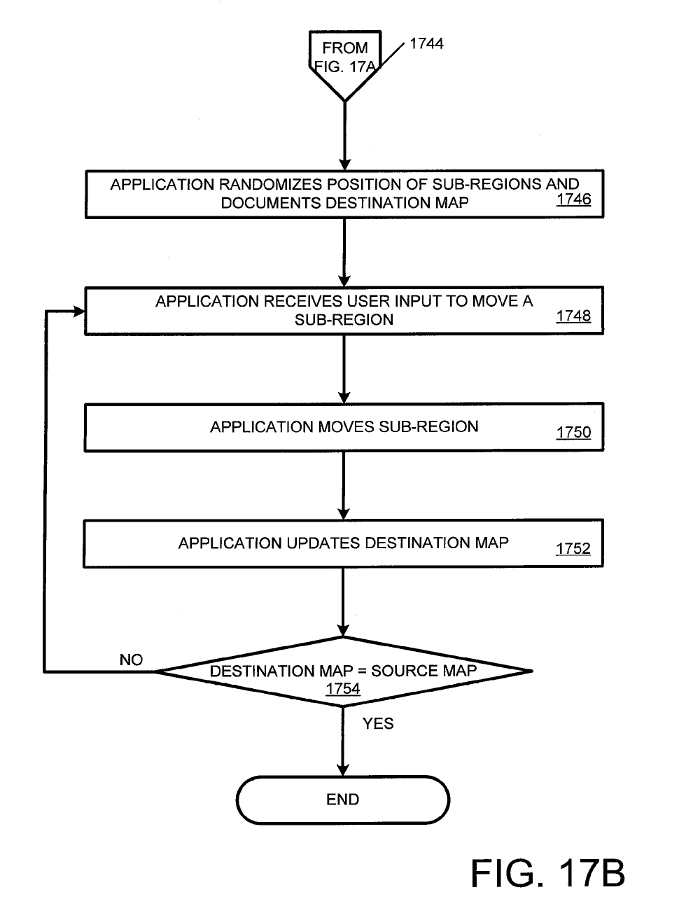

FIG. 17A is a flowchart illustrating an embodiment of steps that may be taken in providing scrambled video, such as the video from FIG. 11.

FIG. 17B is a continuation of the flowchart from FIG. 17A.

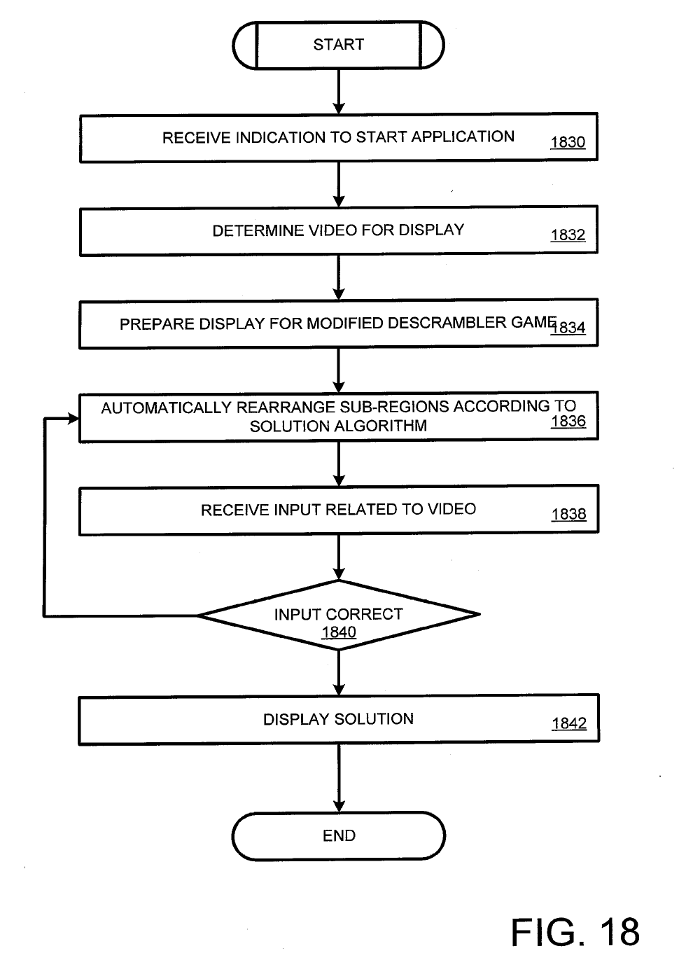

FIG. 18 is a flowchart illustrating an embodiment of an automatic rearrangement of a scrambled video display, such as the video display from FIG. 11.

### DETAILED DESCRIPTION

FIG. 1 is an embodiment of a descrambler game for arranging a plurality of sub-regions within an enclosed space. As illustrated, the “descrambler game” 100 may include a rectangle 102 that houses a plurality of sub-regions 1-9 within the rectangle 102. In this game, one of the sub-regions 104 is missing such that a user can rearrange the sub-regions within the rectangle into a desired configuration.

More specifically, the sub-regions 104 may be scrambled, such as in a random configuration and the user can attempt to rearrange the sub-regions back to the arrangement of FIG. 1. As this nonlimiting example includes only one removed sub-region 104, the user can move one sub-region at a time to achieve the desired arrangement.

FIG. 2 is a block diagram depicting an embodiment of a computing device that may be configured to provide a video display pursuant to the present disclosure. More specifically, computing device 200 may include a Set Top Terminal (STT), such as a cable box, satellite box, etc., for receiving and providing audio and/or video data to a display device. Computing device 200 could also include, among others, a personal computer, a handheld computer, a cellular telephone, and/or other computing devices configured for providing video for display. Computing device 200 may include a radio frequency (RF) output system 212, which may be coupled to a display device 226, such as a television, computer monitor, etc. The RF output system 212 may be configured to receive data from a digital encoder 210. Computing device 200 additionally includes an RF input system 208, which can be configured to communicate with a network 222, which may receive programming data from a headend 224. As discussed in more detail below, the RF input system 208 and the RF output system 212 may include one or more components such as an RF input port and an RF output port, respectively. Also included is a receiver 204 for receiving user commands via a remote control 220.

The computing device 200 may also include a first component output system 214, a first component input system 216, a second component output system 232, a second component input system 233, and an auxiliary input system 230. These input and output systems can be configured to facilitate communication of data between the computing device 200 and other devices.

The computing device 200 may also include a data storage infrastructure, such as volatile and nonvolatile memory 238. Volatile and nonvolatile memory component 238 may include Random Access Memory (RAM), (which may include Dynamic RAM (DRAM), Video RAM (VRAM), Static RAM (SRAM), and/or other components), flash memory 226, one or more hard drives, a CD read and/or write components (e.g., CDROM, CDR, CDRW, etc.), DVD read and/or write components, and/or other types of volatile and nonvolatile memory components. Volatile and nonvolatile memory component 238 may also include one or more software programs such as Pay-Per-View (PPV) component 240, watchtv component 242, navigator component 244, Media On Demand (MOD) component 246, email component 248, an operating system 250, and an application 254. Application 254 may include a graphics stack 256, a capture engine 258, an power draw 260, and a TV manager 262.

As one of ordinary skill in the art will realize, while certain components of FIG. 2 are illustrated as being stored within application 254, this is a nonlimiting example. Depending on the particular configuration, any of these components may reside locally and/or remotely from computing device 200. Additionally, while certain components are illustrated as software components within memory 238, other configurations may provide similar functionality via hardware and/or firmware components.

The computing device 200 may also include a processor 228 for executing instructions from memory component 238. A decoder 234 may be included for decoding received data, as well as a Movie Picture Experts Group (MPEG) demodulator 236. A frame buffer 200, a tuner system 206, and a digital encoder 210 may also be included. Also, depending on the configuration, components for manipulating received analog signals may also be included in this nonlimiting example.

One should also note that while various components are illustrated as relating to computing device 200, this is a nonlimiting example. As one of ordinary skill in the art will realize, more or fewer components may be included to provide a desired functionality for a particular configuration. Additionally, while the components of computing device 200 are arranged in a particular manner, this is also a nonlimiting example, as other configurations are also considered. Similarly, while an RF input system 208, RF output system, component inputs and outputs, and auxiliary outputs are disclosed, these are nonlimiting examples. More specifically, any input and/or output port may be utilized for sending and/or receiving data. Additionally, depending on the particular embodiment, the computing device 200 may have an integrated display such that input and/or output interfaces may be internal to the computing device 200.

With reference to FIG. 1, computing device 200 may be configured with logic to provide any of a plurality of different embodiments of descrambler game 100 discussed above. More specifically, in at least one embodiment, the computing device 200 can be configured to provide a user option to play the descrambler game. The user option can be provided via an interactive menu, however this is not a requirement. The computing device 200 can then receive indication from the user of a desire to play the descrambler game. Upon receiving the user input, the computing device 200 can capture live video and divide the captured live video into a plurality of sub-regions. The plurality of sub-regions can be arranged in a random (or quasi-random) configuration, with one of the sub-regions missing. The user can then (via an input device such as a remote control, mouse, keyboard, etc.) rearrange the live video sub-regions until the video is appropriately configured.

Other configurations can provide a screen saver functionality. More specifically, in at least one embodiment, in response to a determining that the computing device 200 has experienced a predetermined amount of idle time, the computing device can enter a screen saver mode. The screen saver mode can access a video (via any of a plurality of different sources), divide the video into a plurality of sub-regions, randomize the configuration of sub-regions, and automatically rearrange the sub-regions into the appropriate configuration.

Still other configurations can provide a variation of the descrambler game where the computing device 200 divides a video display into a plurality of sub-regions. The configuration of the sub-regions may be randomized and rearranged (by the computing device) such that users can guess the title of the video program being displayed. In such a configuration, a winner can be determined via user input (via a keyboard, mouse, microphone, and/or other input device). Such a game can be played among users of the same computing device 200 and/or among users of different computing devices, such as via the Internet (and/or other network).

FIG. 3 is an embodiment of a video display that may be provided by the computing device from FIG. 2. More specifically, the computing device 200 may receive a video signal from the headend 224 via RF input system 208. Other embodiments may include receiving a video signal via auxiliary input 230, first component output system 216, second component output system 233, and/or memory component 238. The video signal may be displayed as video display 300 via a display device 226, which may or may not be external to computing device 200. Depending on the particular source of the video signal and the particular display device, video display 300 may be displayed as a series of frames that are displayed at a rate that provides dynamic motion video. More specifically, depending on the particular configuration, the video display 300 may be displayed at 15 frames per second, 30 frames per second, 60 frames per second, or other frame rate.

FIG. 4 is an embodiment of a video guide that may be configured to provide a games option from the video display from FIG. 3. As illustrated in FIG. 4, video display 300 is placed in the top right corner of guide 400. On the left side of guide 400 is a description of the program and episode being displayed. Additionally in guide 400 is a listing of programs on various channels being scheduled for display at various times. At the bottom of guide 400 is a “browse by” option 402, which may be accessed by selecting the “A” option on a remote control, keyboard, or other input device. Similarly, by selecting the “B” option, the user can be displayed with the current date and time. By selecting the “C” option, the user can access a games menu.

FIG. 5 is an embodiment of a games menu for selecting a version of a descrambler game, the menu being accessible via the guide from FIG. 4. As illustrated in FIG. 5, menu 500 includes the video display 300 (which may be resized to fit in menu 500), as well as a description of the games menu in the top left corner. Also included in menu 500 is a listing of games that may be available to the user. More specifically, the user may access a descrambler game via option 502, a video descrambler game via option 504, a modified video descrambler game via option 506, and a modified video descrambler remote game via option 508. As discussed above, the descrambler game 100 may be accessed and played with static sub-regions. The user may rearrange the sub-regions (sometimes referred to as “tiles”) using a keyboard, remote control, mouse, and/or other input device. Additionally, the user may access a video descrambler game, which is described in more detail below.

FIG. 6 is an embodiment of video divisions that may be made to provide a video scrambling functionality with the computing device from FIG. 2. By selecting the video descrambler game option 504, the computing device 200 can capture video (from a current channel, a stored video, and/or other source) and divide the captured video into a plurality of sub-regions. The divisions can be similar to those in video display 600, however other embodiments may have more or fewer sub-regions, and may or may not be rectangular in shape.

FIG. 7 is an embodiment of a destination mapping system for the video divisions from FIG. 6. Pursuant to the division of a video frame illustrated in FIG. 8, each sub-region may be assigned a destination address, as illustrated with numerals 1-12 in video display 700. The destination addresses may or may not be displayed to the user and may signify a predetermined sub-region according to the original arrangement of the sub-regions. As indicated in video display 700, the sub-region that originates at the top left corner, is indicated with a “1.” Other similar addresses may be provided as illustrated in FIG. 7.

One should note that while the destination addresses in FIG. 7 are illustrated as base-10 numerals, this is a nonlimiting example. More specifically, depending on the configuration, the destination addresses can be assigned according to a 2-dimensional array and/or other addressing scheme.

FIG. 8 is an embodiment of a source mapping system and associated destination mapping system, similar to the destination mapping system from FIG. 7. More specifically, a source address is associated with a predetermined position on a video display. As illustrated in this nonlimiting example, the top left position (which may be identified via a predetermined pixel array) on a display device 226 has been assigned a source address of “A.” Similarly, other source addresses are assigned to the remaining areas of the display area, as denoted with addresses B-L.

Similar to the discussion in FIG. 7, while the source addresses in FIG. 8 are illustrated as characters A-L, this is a nonlimiting example. More specifically, depending on the particular configuration, any of a plurality of addressing schemes may be employed.

FIG. 9 is an embodiment of scrambling of a video program, according to the divisions from FIG. 6. Video display 900 includes a frame of video (from FIG. 7), in which the sub-regions have been rearranged in a random (or quasi-random) manner for the descrambler game. As the sub-regions are randomized, the destination addresses associated with those sub-regions are rearranged accordingly. As indicated above, while the embodiment of FIG. 9 illustrates the destination addresses as visible characters on the video display 900, this is a nonlimiting example, as other configurations may omit displaying destination addresses, and/or display the destination addresses in response to a user command.

FIG. 10 is an embodiment of a source mapping system and associated destination mapping system pursuant to the video scrambling from FIG. 9. With the randomization of the position of the sub-regions illustrated in FIG. 9, the computing device 200 can be configured to maintain a relationship of the source addresses (which may not change) with the destination addresses, as illustrated in FIG. 10. More specifically, sub-region “1” is now associated with the source address “G.” As the user (or computing device 200) arranges the sub-regions to solve the puzzle, the destination addresses may change. The computing device 200 can be configured to document the new destination address arrangement. After each rearrangement, the computing device 200 can make a determination whether the source addresses and destination addresses are arranged according to the desired configuration. In this nonlimiting example, the computing device 200 can determine a proper alignment when source address “Λ” is paired with destination address “1,” source address “B” is paired with destination address “2,” etc., as illustrated in FIG. 8.

FIG. 11 is an embodiment of a video display, illustrating removal of a sub-region from the scrambled video program from FIG. 9. In at least one configuration of the descrambler game, all sub-regions may be present and the user can “swap” any two sub-regions. However, other embodiments may include removal of one or more sub-regions by the computing device 200, such that a user (and/or the computing device 200) can move a sub-region into vacant sub-region space when arranging the sub-regions into the desired configuration. More specifically, as illustrated in video display 1100, the bottom right sub-region 1102 has been removed. By removing a sub-region from the video display, the user (and/or computing device 200) can move either sub-region “4” or sub-region “11” (the sub-regions that are adjacent to the removed sub-region) into the vacant area. By moving a tile into the vacant region, a vacant region will now be present at a different source address. The user (and/or computing device 200) can continue shifting tiles into the vacant region until the tiles are arranged in the desired configuration.

FIG. 12 is an embodiment of a source mapping system and associated destination mapping system pursuant to the video display from FIG. 11. As illustrated in FIG. 11, source address “L” has no corresponding destination address, as there is a vacant tile 1102 at source address “L.” Additionally, as the tiles are rearranged, the computing device 200 can make a determination whether the tiles are arranged in the desired configuration. As there is at least one tile missing from the image, the computing device 200 can further determine the desired configuration including the vacant tile 1102. As a nonlimiting example, the computing device 200 can determine whether all unvacant tiles are arranged according to the desired configuration and infer that the vacant tile 1102 is appropriately positioned. Other configurations can determine the desired position for the vacant tile 1102 and then determine whether all tiles are appropriately positioned.

FIG. 13 is an embodiment of a video display, illustrating an on-screen user cursor for executing a descrambler game for the video display from FIG. 12. More specifically, in a video descrambler game, a user can, via an input device, select a tile that the user desires moved into the vacant space. To facilitate this, the computing device 200 can present the user with an on-screen cursor 1302 that surrounds a tile. After positioning the cursor over the desired tile, the user can select an execute button and the computing device can move the selected tile to the vacant area.

One should note that while the cursor illustrated in FIG. 13 is depicted as a rectangle that surrounds a tile, this is a nonlimiting example. More specifically, any cursor/indicator may be implemented, including but not limited to shading one or more tiles, pulsating one or more tiles, coloring one or more tiles, etc.

FIG. 14 is an embodiment of a video display, illustrating the dynamic nature of video scrambling from FIG. 13. As illustrated in video display 1400, while the descrambler game is being played, the received video may be changing. As the received video changes, the tiles of the descrambler game may also change, as they may be a representation of a portion of the received video.

One should also note that while the tiles are scrambled, the user can provide other inputs to the computing device. As a nonlimiting example, the user can change the video being displayed (e.g., change channels, change an input from television to Digital Video Disc, etc.). Other embodiments can provide that the computing device 200 has a plurality of input devices. One (or more) of the input devices can be configured to change the video being displayed, while another (one or more) input device can be configured for rearrangement of the sub-regions.

FIG. 15 is an embodiment of a video display, illustrating a desired arrangement of the sub-regions from FIG. 14. More specifically, video display 1500 is similar to video display 1400, with the tiles properly arranged. When the tiles are arranged in this manner, the computing device 200 can determine that the source addresses correspond to the appropriate destination addresses.

FIG. 16 is an embodiment of a video display illustrating a resumption depicted in the video display from FIG. 15. As illustrated in video display 1600, in response to the computing device 200 determining that the tiles are properly arranged, the computing device can remove the sub-region divisions and provide an indication that the tiles are properly arranged.

Referring back to FIG. 5, if the user selects the modified video descrambler game option 506, a different variation of the game may be presented. In one such variation, the computing device 200 can be configured to automatically randomize the sub-regions and then automatically arrange the tiles into the proper configuration. During the arrangement of the tiles, one or more teams of users can try to guess the one or more aspect of the video being displayed (e.g., the video title, the characters, episode, etc.). The users can submit their guesses via a keyboard, via a microphone (using voice recognition), and/or other input device.

Referring again to FIG. 5, if the user selects the modified video descrambler remote game option 508, a game similar to the modified video descrambler game can be played. However, as opposed to the previous example, where the users can all be submitting input to the same computing device 200, option 508 allows at least one of the users to play the game via a virtual connection through the Internet and/or other network. More specifically the remote players can be provided the same video and the same arrangement of tiles. As the tiles are rearranged (in a similar fashion for the remote players), the players can guess various aspects of the video being displayed. As the same presentation is given to the remote players, a dedicated server can be configured to facilitate this functionality, however this is not a requirement, as such functionality can be provided in a distributed configuration.

Additionally, other embodiments can provide a user option to return the scrambled video back to an unscrambled configuration for viewing, while maintaining the current arrangement of the sub-regions. More specifically, if a user is playing the video descrambler game and wants to watch the video being displayed, the user can select a quick view option to return the display for video viewing. The video descrambler game can resume upon receipt of user input and/or after a predetermined amount of time.

Still other embodiments can provide a screen saver functionality for the computing device 200 and display device 226. More specifically, in at least one embodiment, after a predetermined amount of idle time, a computing device 200 may enter a screen saver mode. In such a scenario, the application 254 can begin facilitating display of the divided video. As indicated above; the application 254 can divide the video into a plurality of sub-regions and rearrange the sub-regions into a random (or quasi-random) arrangement. The application 254 can then return the sub-regions to the desired configuration and repeat the process until the computing device 200 leaves screen saver mode.

FIG. 17A is a flowchart illustrating an embodiment a process used to provide scrambled video, such as the video depicted in the display of FIG. 11. At block 1730, application 254 can receive an indication to start the video descrambler application. The application 254 can then prepare a display for the descrambler game (blocks 1732 to 1746). As a nonlimiting example, at block 1732, the application 254 does this by first calling TV manager 262 to set up a video stream for display. More specifically, TV manager 262 can be configured to tune to a specific incoming frequency (or input source), to set up either the analog and/or digital decoders. The TV manager 262 can then route the video to a specified destination (e.g., to a video “plane”). The capture engine 258 can then retrieve and/or digitize a frame of incoming video send this data toto a memory buffer specified by the application 254.

Next, the application 254 can call capture engine 258 to copy the received video frame to memory 238. (block 1734). The application 254 can then divide the video frame into discrete sub-regions (block 1736) and then call power draw 260 to copy a sub-region to display unit 226 (block 1738). The application 254 can then determine whether all sub-regions have been copied (block 1740). If all desired sub-regions have not been copied, the application 254 can call power draw to copy the next sub-region to the display unit (block 1738). This cycle can continue until all desired sub-regions have been copied. If the application 254 determines that all sub-regions have been copied, the application 254 can determine a source map and a destination map for the sub-regions (block 1740). The flowchart can then proceed to jump block 1742.

FIG. 17B is a continuation of the flowchart from FIG. 17A. From jump block 1744, the application 254 can randomize the position of the sub-regions and document the new positions on the destination map (block 1746). The application 254 can then receive user input to move a sub-region (block 1748). Upon receiving the user input, the application 254 can move the selected sub-region (block 1750). The application 254 can then update the destination map (block 1752). The application 254 can then determine if the destination map corresponds to the source map (block 1754). If not, the flowchart returns to block 1748, where the application 254 can receive user input to move another sub-region. The process continues until the application 254 determines that the source map corresponds to the destination map.

One should note that FIGS. 17A and 17B illustrate the presentation of one frame of video. However, in presenting motion video to a user, a plurality of frames may be sequentially displayed. As such, the steps described above may be repeated for each frame displayed to the user.

FIG. 18 is a flowchart illustrating an embodiment of a process for automatic rearrangement of a scrambled video display, such as the video display from FIG. 11. At block 1830, the computing device 200 to receive an indication to start application 254. The computing device 200 can then determine the video for display (block 1832). As indicated above, the video can be received from any of a plurality of sources, including but not limited to a headend, DVD player, memory, etc.

Once the video is received, the computing device 200 can prepare the display for the modified descrambler game (block 1834). As indicated above, this step can include blocks 1732 to 1746 from FIG. 17. Once the display is prepared, the computing device can automatically rearrange the sub-regions according to a solution algorithm (block 1836). More specifically, the computing device 200 can include logic for determining a desired arrangement of sub-regions. The logic can arrange the sub-regions in a highly efficient manner or a less efficient manner, depending on the desired skill level for the game. While arranging the sub-regions, the computing device 200 can receive user input related to the displayed video (block 1838). More specifically, the user input can signify that the user knows one or more aspects of the displayed video (title, characters, episode, etc.). The computing device 200 can then determine whether the input is correct (block 1840). If the received input is not correct, the computing device 200 can continue rearranging the sub-regions (block 1836). If, on the other hand, the received input is correct, the computing device can facilitate display of the solution and the unscrambled video (block 1842).

While the description of FIGS. 17A and 17B can potentially refer to steps that application 254 can perform and the description of FIG. 18 can potentially refer to steps that computing device 200 can perform, these are nonlimiting examples. More specifically, depending on the particular configuration any component with the desired functionality can perform one or more of the blocks in these examples.

Additionally, while the embodiments described herein can be utilized upon receipt of user input and/or as a screen saver, these are nonlimiting examples. Other configurations can provide one or more of the descrambler embodiments during processing and/or wait times for the STT. More specifically, in situations when the STT is uploading and/or downloading information from a headend, the STT can automatically provide a descrambler embodiment. Other situations may include a time when a “please wait” banner is displayed. Other configurations are also included within the scope of this disclosure.

One should note that the flowcharts included herein show the architecture, functionality, and operation of a possible implementation of software. In this regard, each block can be interpreted to represent a module, segment, or portion of code, which comprises one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order or not at all, depending upon the functionality involved.

One should note that any of the programs listed herein, which can include an ordered listing of executable instructions for implementing logical functions, can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can contain, store, communicate, propagate, or transport the program for use by or in connection with the instruction execution system, apparatus, or device. The computer readable medium can be, for example but not limited to, an electronic, magnetic, optical, electromagnetic, infrared, or semiconductor system, apparatus, or device. More specific examples (a nonexhaustive list) of the computer-readable medium could include an electrical connection (electronic) having one or more wires, a portable computer diskette (magnetic), a random access memory (RAM) (electronic), a read-only memory (ROM) (electronic), an erasable programmable read-only memory (EPROM or Flash memory) (electronic), an optical fiber (optical), and a portable compact disc read-only memory (CDROM) (optical). In addition, the scope of the certain embodiments of this disclosure can include embodying the functionality described in logic embodied in hardware or software-configured mediums.

It should be emphasized that the above-described embodiments are merely possible examples of implementations, merely set forth for a clear understanding of the principles of this disclosure. Many variations and modifications may be made to the above-described embodiment(s) without departing substantially from the spirit and principles of the disclosure. All such modifications and variations are intended to be included herein within the scope of this disclosure.

One should also note that conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more particular embodiments or that one or more particular embodiments necessarily include logic for deciding, with or without user input or prompting, whether these features, elements and/or steps are included or are to be performed in any particular embodiment.

Therefore, at least the following is claimed:

1. A method for providing sub-divided video, comprising:
dividing frames of a video stream into sub-regions, each of the sub-regions being configured to provide motion video for display;
determining positions of the sub-regions that are configured to provide video for display;
rearranging at least one of the sub-regions from the determined positions; and
facilitating display of the rearranged sub-regions of the video stream.

2. The method of claim 1, further comprising storing at least one video frame related to the video stream.

3. The method of claim 1, wherein facilitating display of the rearranged sub-regions includes sending data related to the rearranged sub-regions to a display device.

4. The method of claim 1, wherein rearranging at least one of the sub-regions includes removing at least one of the sub-regions to provide a vacant sub-region.

5. The method of claim 4, further comprising receiving user input related to returning the sub-regions to the determined positions by moving at least one sub-region into the vacant sub-region.

6. The method of claim 4, further comprising automatically returning the sub-regions to the determined positions by moving at least one sub-region into the vacant sub-region.

7. The method of claim 1, further comprising providing a quick view to temporarily return the sub-regions to the determined position.

8. A video device for providing sub-divided video, comprising:
a division component configured to receive a plurality of video frames related to a video, the division component further configured to divide the received video frames into a plurality of sub-regions, the sub-regions being organized in a first configuration, the sub-regions being configured to provide motion video related to the divided video frames;
an arrangement component configured to change the arrangement of the sub-regions from the first configuration to a second configuration; and
a power draw component configured to copy the sub-regions in the second configuration to a display device for display in the second configuration.

9. The video device from claim 8, further comprising a memory component configured to store at least a portion of the received video frames.

10. The video device from claim 8, further comprising the display device, the display device being configured to display the received sub-regions in the second configuration.

11. The video device from claim 8, wherein the second configuration is a random arrangement of the sub-regions.

12. The video device from claim 8, wherein the second arrangement includes a vacant sub-region.

13. The video device from claim 8, further comprising an input device configured to facilitate returning the sub-regions to the first configuration.

14. The video device from claim 8, further comprising a rearrangement component further configured to automatically return the sub-regions to the first configuration.

15. A computer readable medium for providing sub-divided video, comprising:
logic configured to divide a video stream into sub-regions, each of the sub-regions being configured to provide motion video for display;
logic configured to determine positions of the sub-regions;
logic configured to rearrange at least one of the sub-regions from the determined positions; and
logic configured to facilitate display of the rearranged sub-regions of the video stream.

16. The computer readable medium of claim 15, further comprising logic configured to store at least one video frame related to the video stream.

17. The computer readable medium of claim 15, wherein facilitating display includes sending data related to the rearranged sub-regions to a display device.

18. The computer readable medium of claim 15, wherein rearranging at least one of the sub-regions includes removing at least one of the sub-regions to provide a vacant sub-region.

19. The computer readable medium of claim 18, further comprising logic configured to receive user input related to returning the sub-regions to the determined positions by moving at least one sub-region into the vacant sub-region.

20. The computer readable medium of claim 18, further comprising logic configured to automatically return the sub-regions to the determined positions by moving at least one sub-region into the vacant sub-region.
